(19) United States
(12) Patent Application Publication
(10) Pub. No.: US 2007/0262971 A1
(43) Pub. Date: Nov. 15, 2007

(54) Method and device for operating an optical display device

(75) Inventor: Stefan Hahn, Ulm (DE)

Correspondence Address: STEPHAN A. PENDORF, P.A., PENDORF & CUTLIFF, 5111 MEMORIAL HIGHWAY, TAMPA, FL, 33634, US

(73) Assignee: DaimlerChrysler AG, Stuttgart (DE)

(21) Appl. No.: 10/536,681

(22) PCT Filed: Nov. 25, 2003
(86) PCT No.: PCT/EP03/13220

§ 371 Date: May 8, 2006

(30) Foreign Application Priority Data
Nov. 28, 2002 (DE) 102 55 796.9

(51) Int. Cl. G09G 5/00

(52) U.S. Cl. 345/204

(57) ABSTRACT

Poor visibility at night is a tiring and dangerous situation in traffic, feared by many drivers. As a result of poor visibility, the frequency of accidents at night is significantly higher than during the day with good visibility conditions. Cars are thus prospectively fitted with night vision systems, in order to increase safety in traffic. A night vision system used for this purpose generally comprises an illumination unit for illuminating the environment surrounding the vehicle, an image recording unit for collecting environmental data, and an image processing unit for evaluating the environmental data. So that the operation of the night vision system can be adapted to different situations, it must be designed in a flexible manner. To this end, the individual components of the night vision system must be able to be operated in different combinations. In order to achieve this, the components of the night vision system can be individually controlled by means of at least one control signal.

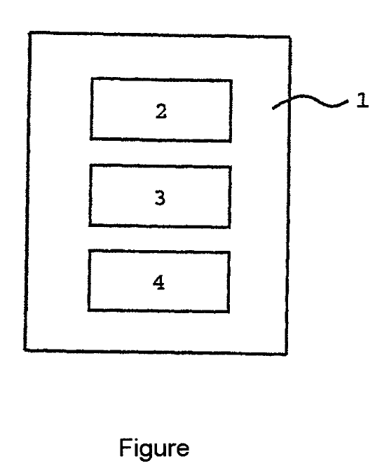

### BACKGROUND OF THE INVENTION

1. Field of the Invention

The invention relates to a method for operating an optical display device, and to an optical display device for using the method.

2. Related Art of the Invention

There are many different types of optical displays that are used for the most varied fields of application. The information displayed by means of an optical display is used in many instances as a control function or as additional information that is read out by the user when required. In order to avoid being distracted by the optical display, developments have been made in which the information to be displayed is projected directly into the user's field of view. These are so-called head-up displays (HUDs). For example, an HUD permits complete concentration on the road traffic, the driver no longer having to look away from the road in order to observe speed displays. In addition to speed displays, it is also possible for information relating to driving conditions and supplied by navigation systems to be projected directly onto the windshield.

Optical display devices that are used in motor vehicles and comprise a number of optical displays are known. Laid-open patent application DE 433-4885 A1 presents a display apparatus for motor vehicles that comprises a first display, designed as mechanical display, and a second display, designed as a luminous display. In which case the luminous display, a liquid crystal display, is reflected into a reflection surface positioned in front of the first display. A number of displays can be rendered visible to the viewer independently of one another by varying the ratio of transmitted and reflected light (transmission) reflection surface positioned in front of the first display. The reflection surface is subdivided into zones in such a way that it is optionally possible for only specific displays, or else all displays, to be rendered visible or faded out. The transmission can be continuously set in this case such that there is no need for a display to be completely faded out and the displays can be superposed on one another.

Optical display devices in which the display variable is varied as a function of the urgency when reproducing information are known from patent application DE 4319904 A1. This document discloses a warning device for displaying information in a motor vehicle. The warning device has an optical display, the information being reflected in the form of a virtual image in a visible zone of the windshield of the motor vehicle. The aim in this case is to ensure that warning information is conveyed to the driver with a high degree of persistence. For this reason, the information respectively of interest is conveyed without change, but is reflected into the windshield on a larger scale as the intensity of warning is raised.

Patent application DE 10046859 A1 from the applicant discloses a system for determining the direction of view and the head position of persons with the aid of image data. In order to detect the direction of view even when head movement is allowed, use is made of a number of facial features in addition to the eyes which include, for example: nose, mouth and eyebrows. For this purpose, the system comprises an apparatus for detecting the eyes that includes a unit for radial matching to which there is connected an apparatus for circle detection (for example based on a Hough transformation). A downstream classifier checks the eye detection and the position thereof inside the image data. A further apparatus of the system permits the direction of view to be determined. In which case this apparatus includes a device for segmenting the image data belonging to the eyes and the nose, downstream of which a classifier is connected.

A system for optical display is described in the Japanese patent application with the publication number 2000029618A. The system comprises an optical display and a spectacle frame that the user must wear while operating the system. The zone to be displayed by means of the optical display is adapted to the user's field of view. It is necessary for this purpose to detect the user's position and direction of view. A number of LEDs are fitted on the spectacle frame for the purpose of detecting the user's position. The light emitted by the LEDs, and their position, are detected by photo-detectors, the photodetectors being fitted at the four corners of the optical display. The user's direction of view is determined in addition, and further photodetectors are also fitted on the spectacle frame. In order to adapt the optical display to the user's field of view, the display device is driven in such a way that the alignment of the optical display is matched to that of the spectacle frame and to the user's direction of view. The system presented is used, in particular, in conjunction with an HUD, the aim being to display the edge of the road and obstacles to the driver of a motor vehicle during night driving. However, with such a system, the user's position and direction of view are used only for the purpose of ascertaining the data volume to be displayed (restriction to the field of view), and of ascertaining the orientation of the view for the display. The aim in this case is for the optical display and the real view to be superposed correctly in geometric terms. A disadvantage here is that the user must wear a spectacle frame without fail.

### SUMMARY OF THE INVENTION

It is therefore the object of the invention to create a method for operating an optical display device, and to create an optical display device with the aid of which a user, in particular the driver of a motor vehicle, is displayed pictorial information, and in which case the optical display is optimized, taking account of the user's position and direction of view, to the fact that there is no need for additional aids for observing the display.

The object is achieved in accordance with the invention by means of a method and an apparatus having the features of patent claims 1 and 8. Advantageous refinements and developments of the invention are indicated in the dependent claims.

In accordance with the invention, use is made of a method for operating an optical display device. The optical display device serves the purpose of displaying information pictorially to the user. In addition, the user's direction of view is detected as the information is being displayed. In a way according to the invention, one of the variables of the pictorial information can be varied as a function of the user's direction of view in the case of the method for operating the optical display device. In which case the variables of the pictorial information can be, in particular, the display variable, shape, color and intensity. The fact that the display variable of information varies as a function of the user's direction of view renders it possible for the first time for the user not to have to look directly at the optical display in order to take in information.

The optical display can be, for example, a display with a fixed display surface (LCD-TFT, OLED, . . . ), or an optical display in the case of which an image is projected (for example HUD, holographic display, . . . ). It is advantageous to vary the information display variable on the basis of computer processing in conjunction with a programmable optical display. An obvious approach to detecting the direction of view is to use an image sensor connected to the computer. In which case image data are taken in by the user with the aid of the image sensor during operation of the optical display device. The image data thereby obtained can then be evaluated with regard to the user's position and direction of view by means of methods of image processing and classification. If the user is not looking directly at the optical display, pictorial information is displayed as larger than is otherwise the case.

In an advantageous embodiment of the invention, the shape of the information to be displayed changes with the user's direction of view. If the user is not looking directly at the optical display, the pictorial information is displayed in another form than is otherwise the case. Before an item of information is displayed, it is advantageous to transform it into a symbolic descriptions. For example, the display of an analog measuring instrument is transformed into a digital display. The information is thereby displayed more accessibly to the user and can thereby be perceived more simply in a peripheral fashion.

In an advantageous refinement of the invention, the position of the information display on the optical display changes with the user's direction of view. If the direction of view is a direction to the left/right next to the optical display, the information is ideally displayed on the left/right-hand edge of the optical display. The information is correspondingly displayed in the direction at the edge of the optical display in which the direction of view exhibits the least deviation from the optical display. If the optical display is a display in which an image is projected (HUD, holographic display, . . . ), the information is displayed in a way similar thereto at the edge of the projected image. In addition, it is obvious in the case of such an optical display to project the complete image in a direction corresponding to the direction of view. Apart from the direction of view, it is greatly advantageous also to use the head position for evaluation purposes. Further facial features (for example nose and mouth) are taken into account in order to determine the head position from image data, as is described in the applicant's patent application having the publication number DE 10046859 A1. Since the position of the information display changes as a function of the direction of view and of the head position, the user can perceive the information effectively even in the case of indirect viewing contact.

In a further advantageous refinement of the invention, the intensity is changed with the user's direction of view when displaying the information. If the user looks directly at the optical display, the information is displayed with lesser intensity than is otherwise the case. It is particularly advantageous when the intensity of the optical display is varied continuously. The deviation of the direction of view from the direction of the optical display is evaluated in order to control the intensity. The information is displayed to the user in such a way that the latter senses a uniform brightness irrespective of the direction of view, and is not dazzled when looking directly at the optical display device.

It is also conceivable to change the color for the information display as a function of the user's direction of view. The color of the background can change markedly, depending on the user's direction of view. In order to achieve as high a color contrast as possible between the displayed information and the background, the color for the display is ideally varied continuously as a function of the user's direction of view. In which case the color for the information display is preferably selected so as to be a color that is complementary to the background. The information display thereby always stands out distinctly from the background.

A further advantageous refinement of the invention provides that the information display is continuously enlarged in the case when the user averts the direction of view from the optical display. The user can thereby recognize the information clearly at any time. By contrast, in the case when the user turns his direction of view to the optical display, the information display variable changes only after a prescribed time interval. This ensures that the user finds the information again immediately on the optical display.

In a particularly advantageous way, the method according to the invention and the optical display device can be used in a road vehicle. For example, the driver is being asked to observe a speed limit on virtually all routes. In order to monitor the observance of the speed limit, the driver must however frequently avert his view from the road and direct it onto the instrument cluster, to the speedometer. Since the instrument cluster is replaced by the inventive method in conjunction with the optical display device, there is no longer a need for the driver to avert his view from the road. The current driving speed is displayed to the driver on the optical display while taking account of his direction of view. If the driver looks onto the road, the current driving speed is preferably displayed in digital form with numerals that are as large as possible. The driver can thereby perceive the display effectively in a peripheral fashion. If the direction of view cannot be determined, or in the case of the optical display being viewed directly, the display is performed with the aid of the usual scale and in a similar form. In conjunction with this type of use, it would also be conceivable to display the currently permissible maximum speed as well as displaying the current driving speed. The permissible maximum speed can be determined, for example, on the basis of automatic traffic sign recognition. The applicant's patent having the patent number DE 19852631 C2 describes for example a method based on the evaluation of image data and also an apparatus for the purpose of traffic sign recognition.

### DETAILED DESCRIPTION OF THE INVENTION

The FIGURE shows by way of example the schematic structure of the optical display device (1) according to the invention. The optical display device (1) in this case comprises an optical display (2) for displaying information. An image sensor (3) for detecting the user's direction of view and his head position. The optical display device (1) further comprises a data processing unit (4) for evaluating the detected data and for processing the information to be displayed.

1. A method for operating an optical display device wherein the user is displayed information pictorially by means of an optical display device, comprising:
detecting the user's direction of view
offering the user the pictorial information in his peripheral field of view, it being possible to vary one of the variables of the pictorial information, in particular the display variable, shape, color and intensity, and
variably changing the information display with the user's direction of view.

2. The method as claimed in claim 1, wherein the shape of the display of information changes with the user's direction of view in order to display information to the user more accessibly.

3. The method as claimed in claim 1, wherein the position of the information display on the optical display device changes with the user's direction of view so that the user can perceive the information effectively in the case of indirect viewing contact.

4. The method as claimed in claim 1, wherein the intensity of the information display changes with the user's direction of view in order not to dazzle the user in the case of looking directly at the optical display device.

5. The method as claimed in claim 1, wherein the color of the information display changes with the user's direction of view so that the information display always stands out distinctly from the background.

6. The method as claimed in claim 1, wherein the information display variable changes continuously when the user's direction of view is averted from the optical display device so that the user can recognize the information clearly at any time.

7. The method as claimed in claim 1, wherein, in the case when the user turns his direction of view to the optical display device, the information display variable changes only after a prescribed time interval so that the user finds the information again immediately on the optical display device.

8. An optical display device by means of which the user is displayed information pictorially, the apparatus comprising a device for detecting the user's direction of view, wherein
the optical display (2) is arranged in the user's peripheral field of view,
a means being provided with the aid of which it is possible to vary one of the pictorial information variables, in particular the display variable, shape, color and intensity, and
a means is provided with the aid of which the information display variable can change as a function of the user's direction of view.

9. The apparatus as claimed in claim 8, wherein the device for detecting the user's direction of view is an image processing device.

10. (canceled)

11. A method for operating an optical display device wherein the user is displayed information pictorially by means of an optical display device, comprising:
detecting the user's direction of view,
offering the user pictorial information in his peripheral field of view, wherein the shape, color and intensity of the pictorial information vary according to relevancy of information and direction of view, and
variably changing the information display such that it remains within the user's peripheral vision.
